(19) United States
(12) Patent Application Publication
(10) Pub. No.: US 2015/0090653 A1
(43) Pub. Date: Apr. 2, 2015

(54) Fuel Filter Cartridge and Method of Construction Thereof

(71) Applicant: Stanadyne Corporation, Windsor, CT (US)

(72) Inventors: Chandrakant Siddharam Kotale, Manchester, CT (US); Kenneth W. Dutil, Farmington, CT (US)

(73) Assignee: Stanadyne Corporation, Windsor, CT (US)

(21) Appl. No.: 14/253,194

(22) Filed: Apr. 15, 2014

Related U.S. Application Data
(63) Continuation-in-part of application No. 14/043,953, filed on Oct. 2, 2013.

(51) Int. Cl. B01D 29/00

(52) U.S. Cl. CPC B01D 29/0093
USPC 210/236; 29/428; 29/525.01

(57) ABSTRACT

A filter cartridge has a longitudinal axis and comprises a housing, a filter element, a first collar and a second collar. The housing has a generally cylindrical sidewall and defines an open first end, an axially opposite second end, and a flange projecting radially away from the axis at the first end. The filter element has a ring of filter media circumscribing the axis and extending between first and second end caps. A ledge projects radially from an inner surface of the second collar. The second collar has an annular sidewall having a shoulder projecting from an inner surface. The ledge and the shoulder radially overlap to retain the flange. The first collar may define axially-oriented grooves configured to receive corresponding radial projections of the first end cap, axially securing the filter element within the housing.

### BACKGROUND OF THE DISCLOSURE

The present disclosure relates generally to devices for filtering and separating liquids. More particularly, the present disclosure relates to fuel filters for removing foreign particles and separating water from fuel in an internal combustion engine.

It is well-documented that significant quantities of contaminants such as water and various abrasive particles are found in diesel fuel. In addition to corroding metal components, water may obstruct the fuel lines when environmental temperatures fall below freezing. Likewise, abrasive particles may damage sensitive engine components such as the fuel injection pump.

Fuel filter cartridges are a well-known solution for removing water and abrasive particles from diesel fuel before the fuel is pumped into sensitive engine systems. Prior art fuel filter cartridges typically have a housing having a threaded or bayonet-type connection to a filter base. The housing typically comprises two housing portions joined at a peripheral shoulder, one of which defines an axial opening to provide fuel communication between the filter base and a filter element disposed within the housing. Customarily, fuel filter cartridges are either replaceable as an entire unit, or the filter element may be coupled to the housing such that the filter unit may be individually replaced.

### SUMMARY

Briefly stated, a fuel filter cartridge in connection with the current disclosure comprises a housing, a filter element and at least one collar. The filter cartridge of the current disclosure is modular, simplifying construction and facilitating replacement of the filter element separate from the remainder of the cartridge.

The housing has a generally cylindrical sidewall and defines an open first end and an axially-opposite second end. The sidewall has inner and outer surfaces and a flange which projects radially away from the outer surface at the first end.

The filter element includes a ring of filter media, which circumscribes the longitudinal axis. The media extends axially between first and second end caps. The first end cap defines a fluid flow opening coaxial with the longitudinal axis.

The cartridge may include first and second collars configured to axially retain the housing upon installation with a filter base, and to provide axially retentive forces during use of the vehicle. The second collar is configured to circumscribe the housing, while the first collar is configured to fit within an inner diameter of the second collar. The first collar and second collars may have a ledge and circumferential shoulder, respectively, which overlap and trap the flange. In one embodiment, a wave spring received in a continuous circumferential pocket defined by the collar provides additional axial retention.

A number of connector systems may be utilized to secure the first collar within the second collar. A snap connector system, a threaded connector system, a threaded connector system having a snap connector portion, and a bayonet connector system may provide a secure connection between the first and second collars, ensuring that strong axial retentive forces secure the housing within the cartridge assembly.

A connector system may also couple the first end cap to the first collar. An inner surface of the first collar may define a plurality of axially-oriented grooves extending between first and second axially-oriented groove ends configured to secure a plurality of radial projections disposed at a circumferential periphery and suspend the filter element within the housing.

A method of manufacturing a filter cartridge of the current disclosure is also contemplated. Briefly stated, the method comprises providing a housing, first and second collar, and filter element having the structures briefly described above, inserting the housing into an inner diameter of the second collar, connecting the first and second collars, and coupling the first end cap to the first collar.

The apparatus and method of the present disclosure provides advantages over and relative to the prior art. For example, the modular filter cartridge is easy to manufacture, yet the structural features of the filter element, housing and collar ensure that the connection between the components is robust enough to resist the adverse effects of engine or road vibration. Furthermore, the seal members provide strong seals with the filter base and the inner surface of the housing.

### BRIEF DESCRIPTION OF THE DRAWING

Aspects of the preferred embodiment will be described in reference to the Figures, where like numerals reflect like elements:

FIG. 1 shows a cross-sectional view of one embodiment of a filter cartridge of the present disclosure;

FIG. 2 shows an enlarged cross-sectional view of one embodiment of a connection between a collar, a housing and a first end cap;

FIG. 3 shows a cross-sectional view of one embodiment of the collar of the assembly of FIGS. 1 and 2;

FIG. 4 shows an enlarged cross-sectional view of an alternate embodiment of the connection between the collar, the housing and the first end cap;

FIG. 5 shows a cross-sectional view of an alternate embodiment of the collar of the assembly of FIG. 4;

FIG. 6 shows an enlarged cross-sectional view of the collar shown in FIG. 5 with particular emphasis on an axial slot, a circumferential pocket and a barb;

FIG. 7 shows an enlarged cross-sectional view of an alternate embodiment of the connection between the collar, the housing and the first end cap;

FIG. 8 shows a cross-sectional view of an alternate embodiment of the collar of the assembly of FIG. 7;

FIG. 9 shows an enlarged cross-sectional view of the collar of FIG. 8 with particular emphasis on a female portion of a threaded connector system and slots defined between snap fingers at a first axial end of the collar;

FIG. 10 shows an enlarged cross-sectional view of an alternate embodiment of the connection between the collar, the housing and the first end cap;

FIG. 11 shows a cross-sectional view of an alternate embodiment of the collar of the assembly of FIG. 10;

FIG. 12 shows an enlarged cross-sectional view of the collar of FIG. 11 with particular emphasis on a circumferential pocket, female portion of a threaded connector system and slots defined between snap fingers at a first axial end of the collar;

FIG. 13 shows a cross-sectional view of an alternate embodiment of the filter element;

FIG. 14 shows a perspective view of a second end cap of the filter element of FIG. 13;

FIG. 15 shows an enlarged cross-sectional view of a connection between the housing and the second end cap;

FIG. 16 shows a top-plan view of one embodiment of the housing;

FIG. 17 shows a cross-sectional view of an alternate embodiment of the housing;

FIG. 18 shows an enlarged cross-sectional view of the embodiment of the housing depicted in FIG. 17 with particular emphasis on a ring between a seat and an open first end of the housing;

FIG. 19 shows a cross-sectional view of one embodiment of the filter cartridge as installed with a compatible filter base;

FIG. 20 shows a perspective view of one embodiment of a wave spring in accordance with certain aspects of the present disclosure;

FIG. 21 shows an exploded view of an alternative embodiment of the filter cartridge of the present disclosure;

FIG. 22 shows a top plan view of the filter cartridge of FIG. 21;

FIG. 23 shows a sectional, side view taken along line X-X of the filter cartridge of FIG. 22;

FIG. 24 shows the sectional view of the filter cartridge shown in FIG. 23, with particular emphasis on the connector system between the first and second collars;

FIG. 25 shows a sectional side view of the filter element and first collar of the filter cartridge of FIG. 21, the housing and second collar are omitted for clarity;

FIG. 26 shows a sectional view, partly in phantom, of the first collar taken along line X-X of FIG. 22;

FIG. 27 shows one embodiment of a circular retaining clip;

FIG. 28 shows an alternative embodiment of the circular retaining clip of FIG. 27;

FIG. 29 shows an exploded view of the first collar, circular retaining clip and filter element of the filter cartridge of FIG. 21, the second collar and housing are omitted for clarity;

FIG. 30 shows a top plan view of the filter cartridge of FIG. 21;

FIG. 31 shows a sectional side view of the filter element and first collar taken along line X-X of the filter cartridge of FIG. 30, the housing and second collar are omitted for clarity;

FIG. 32 shows a top plan view of the filter element of the filter cartridge of FIG. 21, the first collar, second collar, housing and circular retaining clip are omitted for clarity;

FIG. 33 shows a sectional side view of the filter element of FIG. 32 taken along line X-X;

FIG. 34 shows a side view of the filter element of FIG. 32;

FIG. 35 shows an exploded view of an alternative embodiment of the filter cartridge of the present disclosure;

FIG. 36 shows a top plan view of the filter cartridge of FIG. 35;

FIG. 37 shows a sectional view of the filter cartridge taken along the line X-X shown in FIG. 36;

FIG. 38 shows the sectional view of the filter cartridge shown in FIG. 37, with particular emphasis on the connector system between the first and second collars;

FIG. 39 shows a top plan view of the filter cartridge of FIG. 35;

FIG. 40 shows a sectional view of the filter element and first collar taken along line X-X of FIG. 39, the housing and second collar are omitted for clarity;

FIG. 41 shows an exploded view of the filter element and first collar of the filter cartridge of FIG. 35, the housing and second collar are omitted for clarity;

FIG. 42 shows a top plan view of the filter element of the filter cartridge of FIG. 35, the housing, first collar and second collar are omitted for clarity;

FIG. 43 shows a sectional view, partly in phantom, of the first collar taken along line X-X of FIG. 39;

FIG. 44 shows an exploded view of an alternative embodiment of the filter cartridge of the present disclosure;

FIG. 45 shows a top plan view of the filter cartridge of FIG. 44;

FIG. 46 shows a sectional view of the filter cartridge taken along line Y-Y in FIG. 45;

FIG. 47 shows the sectional view of the filter cartridge shown in FIG. 46, with particular emphasis on the connector system between the first and second collars;

FIG. 48 shows a sectional view of the first collar and filter element taken along line X-X of FIG. 45, the housing and second collar are omitted for clarity; and

FIG. 49 shows a sectional view of the first collar taken along line X-X of FIG. 45, the filter element, housing and second collar are omitted for clarity.

### DETAILED DESCRIPTION

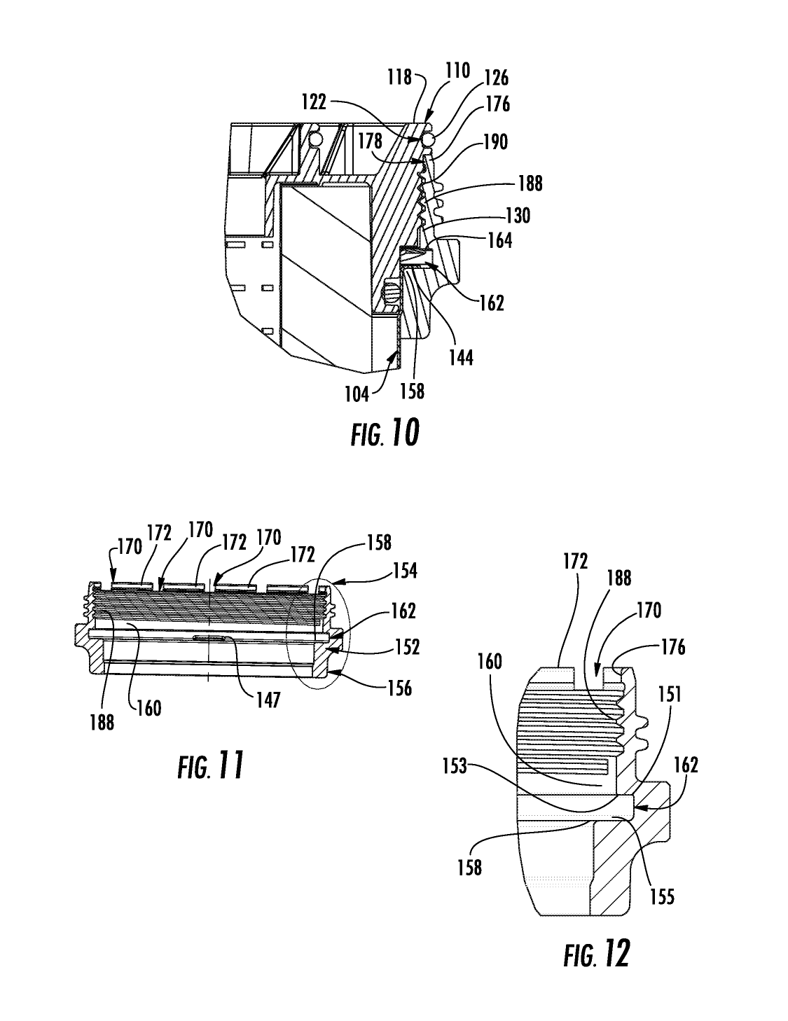

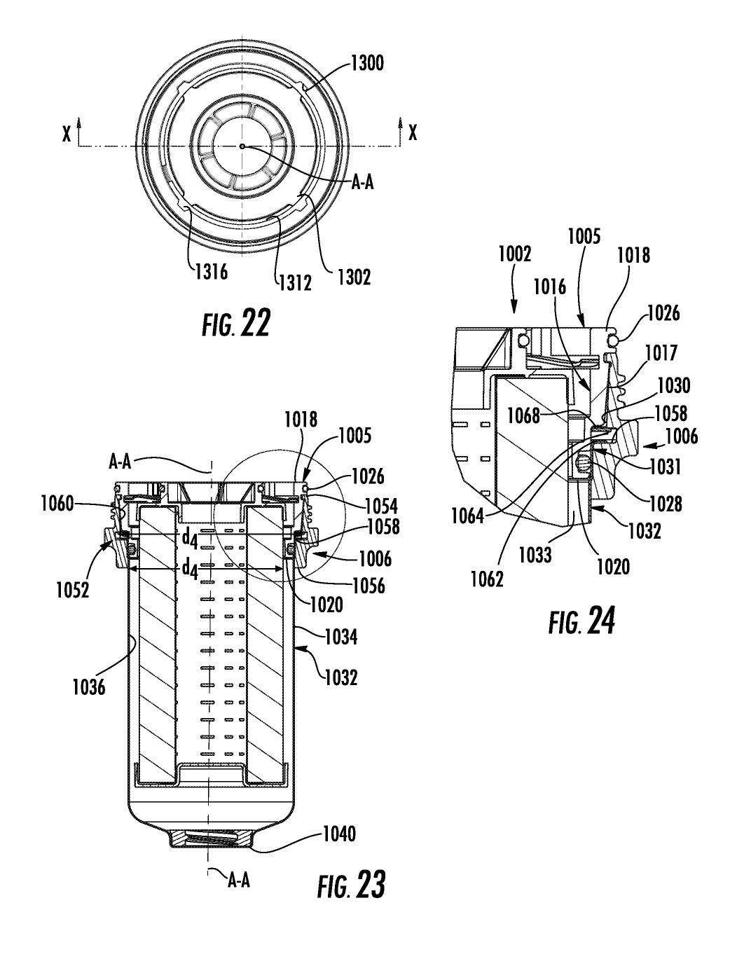

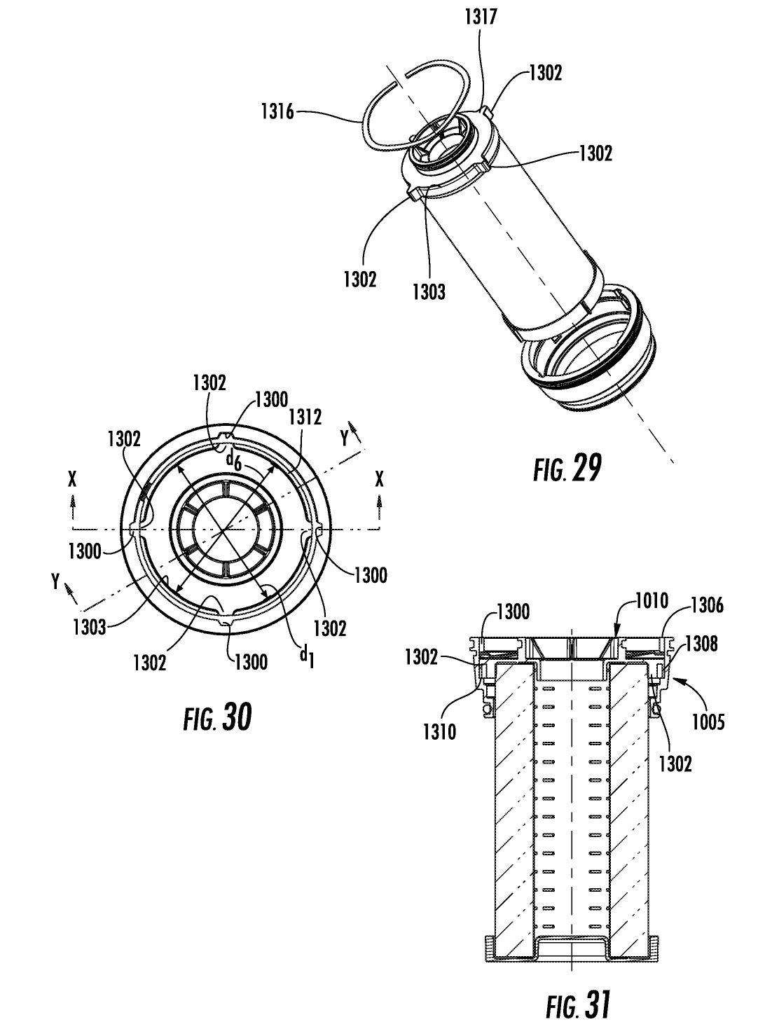

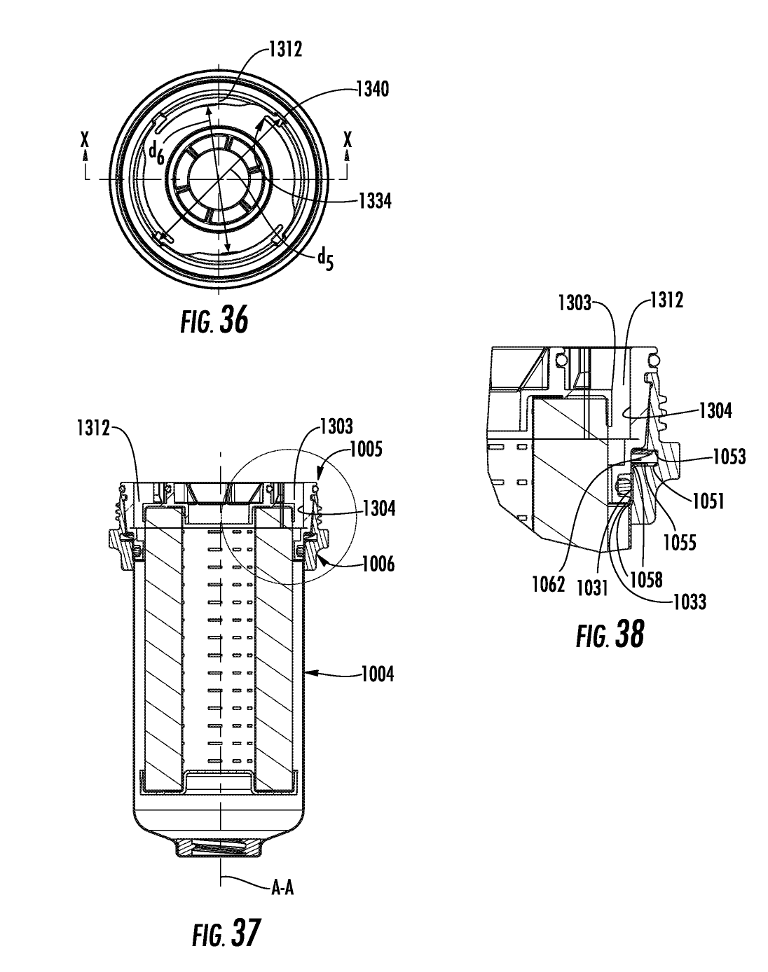

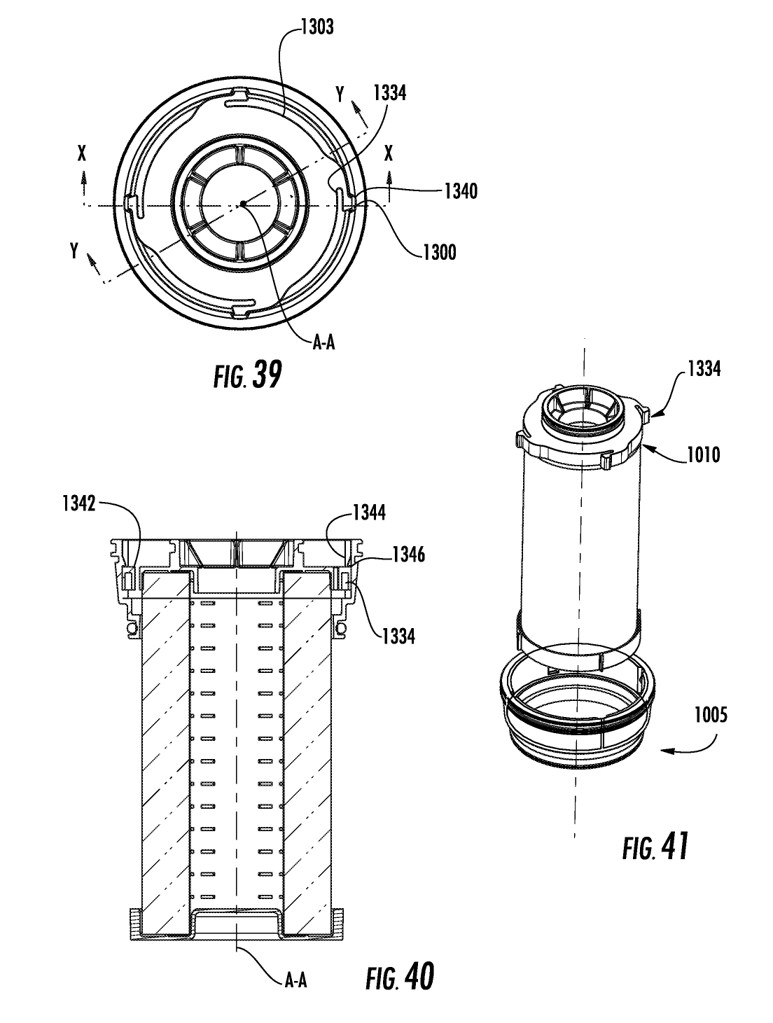

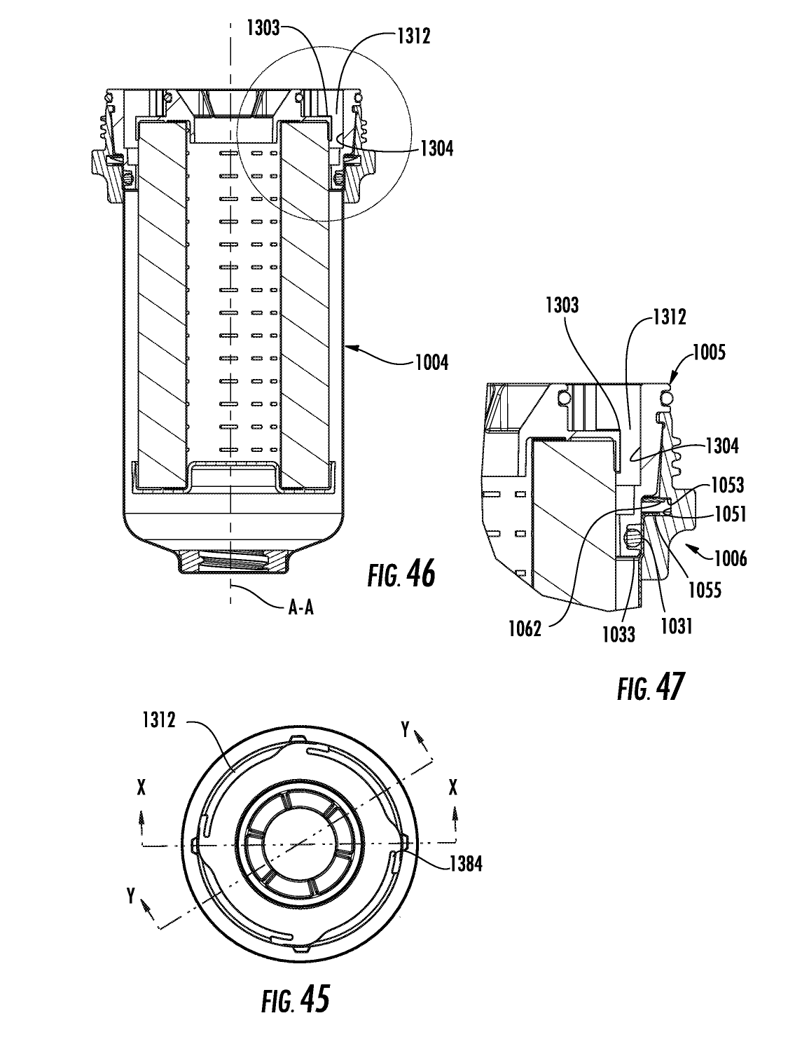

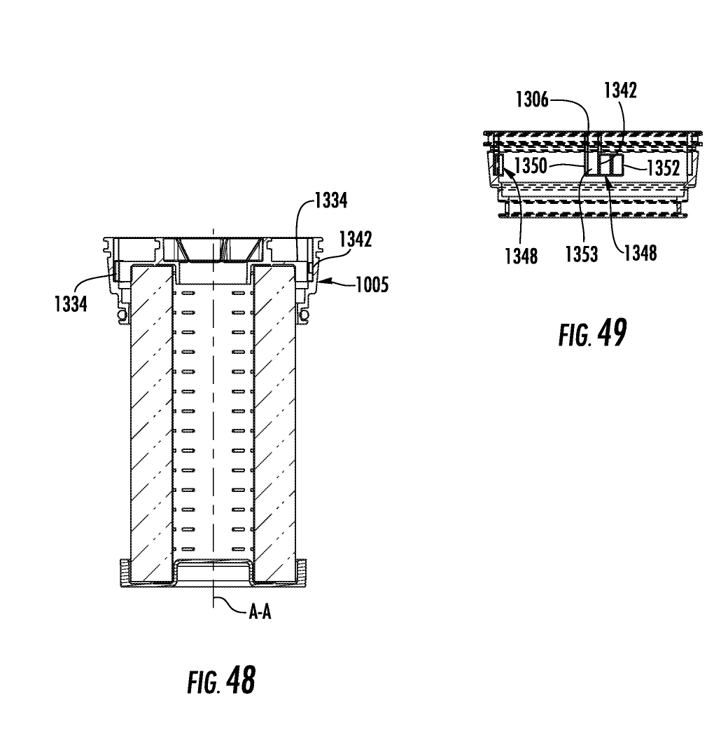

Embodiments of a filter cartridge will now be described with reference to the Figures, wherein like numerals represent like parts throughout the FIGS. 1-49. FIG. 1 illustrates one embodiment of a filter cartridge 100 according to aspects of the disclosure. The filter cartridge 100 has a longitudinal axis A-A and includes a filter element 102, a housing 104 and a collar 106. The filter cartridge 100 is contemplated for use with a filter base 108 (see FIG. 19).

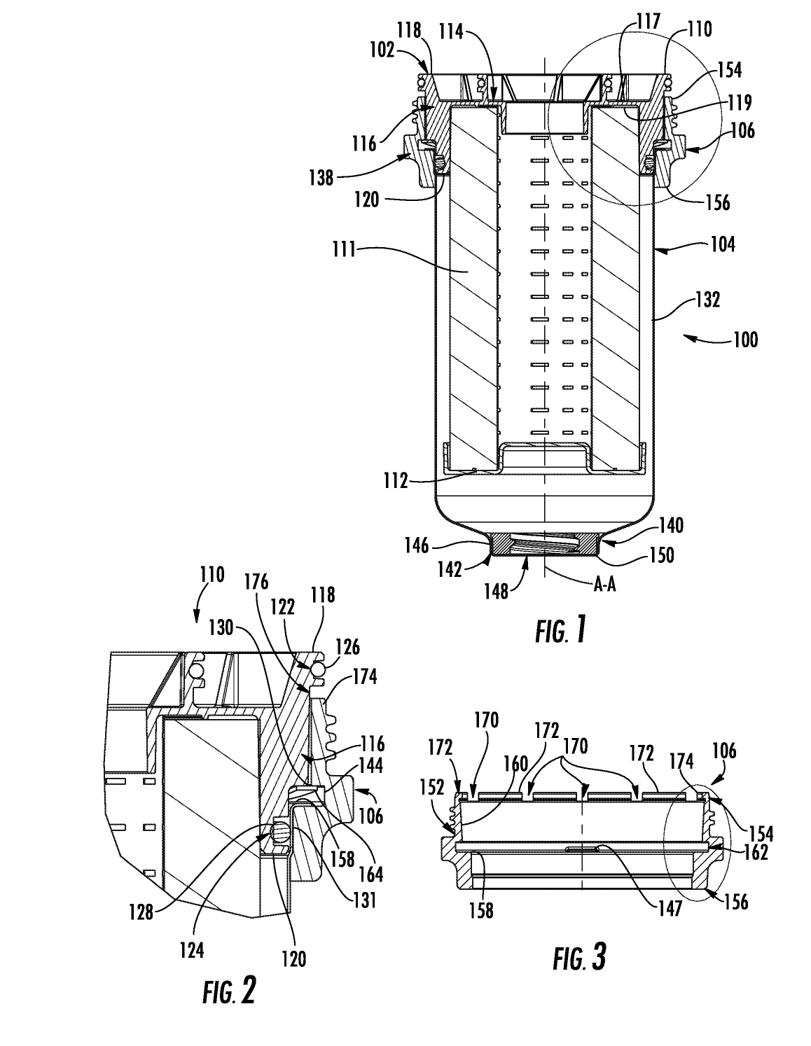

The filter element 102 includes first and second end caps 110 and 112, respectively. The first end cap 110 defines a fluid flow opening 114 coaxial with the longitudinal axis A-A. As also shown in FIG. 2, a generally cylindrical wall 116 is disposed at a circumferential periphery of the first end cap 110. The first end cap 110 includes first and second surfaces 117 and 119, respectively, which extend between the circumferential periphery and the fluid flow opening 114.

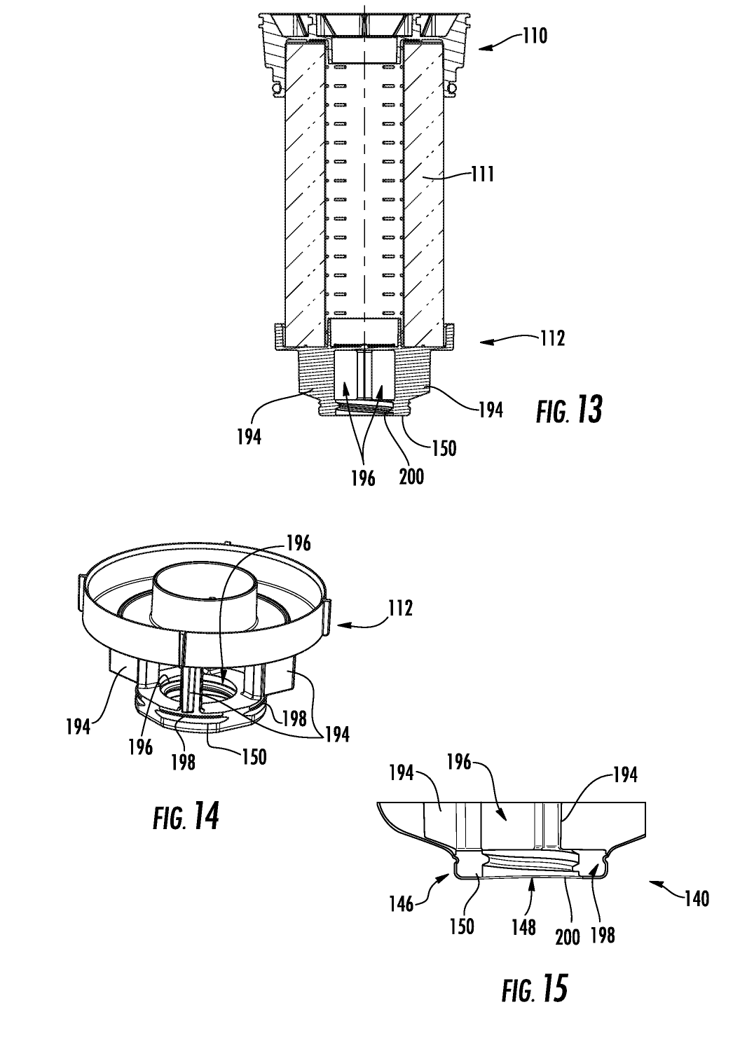

The cylindrical wall 116 extends between a first and second peripheral rim 118 and 120, respectively, and defines first and second seal glands 122 and 124, respectively. In the embodiment shown in FIGS. 1 and 13, the cylindrical wall 116 of the upper end cap 110 tapers between the first and second peripheral rims 118 and 120. The first and second seal glands 122 and 124 are respectively defined adjacent the first and second peripheral rims 118 and 120, and oriented radially away from the longitudinal axis A-A. The first and second seal glands 122 and 124 receive first and second seal members 126 and 128, respectively. A ledge 130 projects radially outwardly from the cylindrical wall 116 intermediate the first and second peripheral rims 118 and 120.

In one embodiment best seen in FIG. 19, an annular inner wall 121 projects axially away from the first end cap 110 first surface 117. The annular inner wall is disposed adjacent the fluid flow opening 114 and radially inward of and concentric with the cylindrical wall 116. A third seal gland 123 is oriented radially away from the longitudinal axis A-A, and sized to receive a third seal member 125. The inner wall 121 and third seal gland 123 are configured to sealingly mate with a fuel conduit 107 of the filter base 108. The fuel conduit is disposed radially inwardly of a skirt 109 which sealingly mates with the first seal member 126.

Fuel entering the filter base 108 flows from inlet ports 127 as designated by the arrows. The first seal between the first seal member 126 and the skirt 109 prevents fuel leaking out between the first end cap 102 collar 106 and skirt 109. “Dirty” fuel flows into a plurality of filter ports 129 defined at the circumferential periphery, and subsequently into a space between the filter media 111 and a generally cylindrical housing sidewall 132. Water and other abrasive impurities are filtered from the “dirty” fuel as the fuel flows through the filter media 111, and filtered “clean” fuel flows through the fluid flow opening 114 and out the fuel filter base 108. The third sealing interface between the third seal member 125 and the fuel conduit 107 separates filtered “clean” fuel destined for the fuel injectors and/or other downstream engine components from “dirty” fuel pumped in from the fuel tank.

Referring to FIGS. 1 and 17, the sidewall 132 is coaxial with the longitudinal axis A-A. The sidewall 132 has inner and outer surfaces 134 and 136 and defines an open first end 138 and an axially-opposite second end 140. A flange 144 projects radially away from the outer surface 136 at the open first end 138. As will be described in further detail below, the flange cooperates with the first end cap 110 and the collar 106 to retain the filter element 102 within the housing 104.

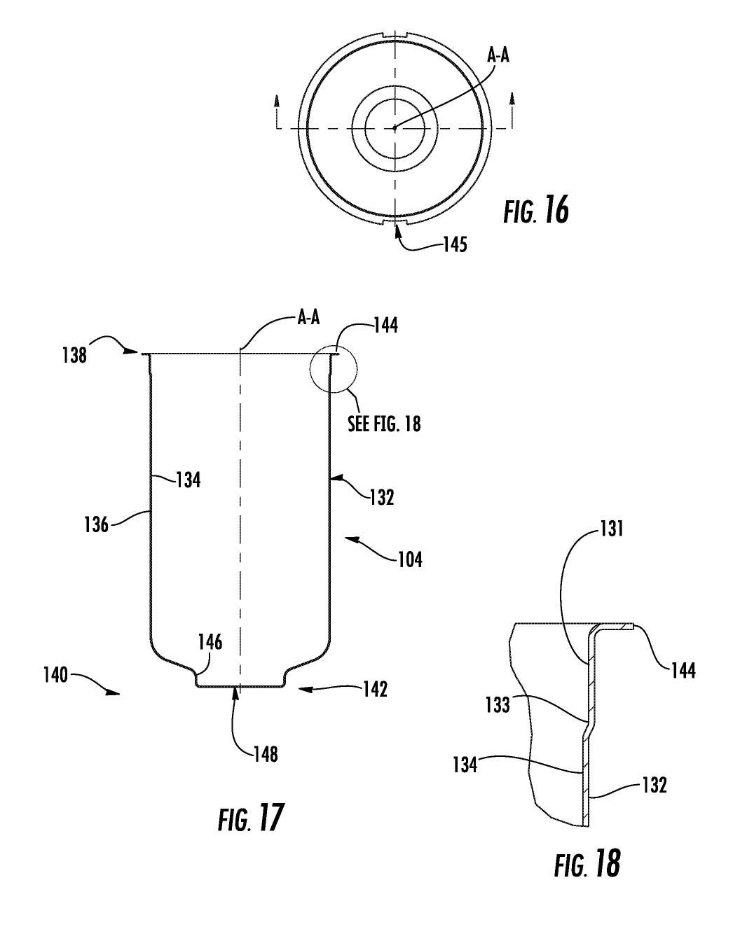

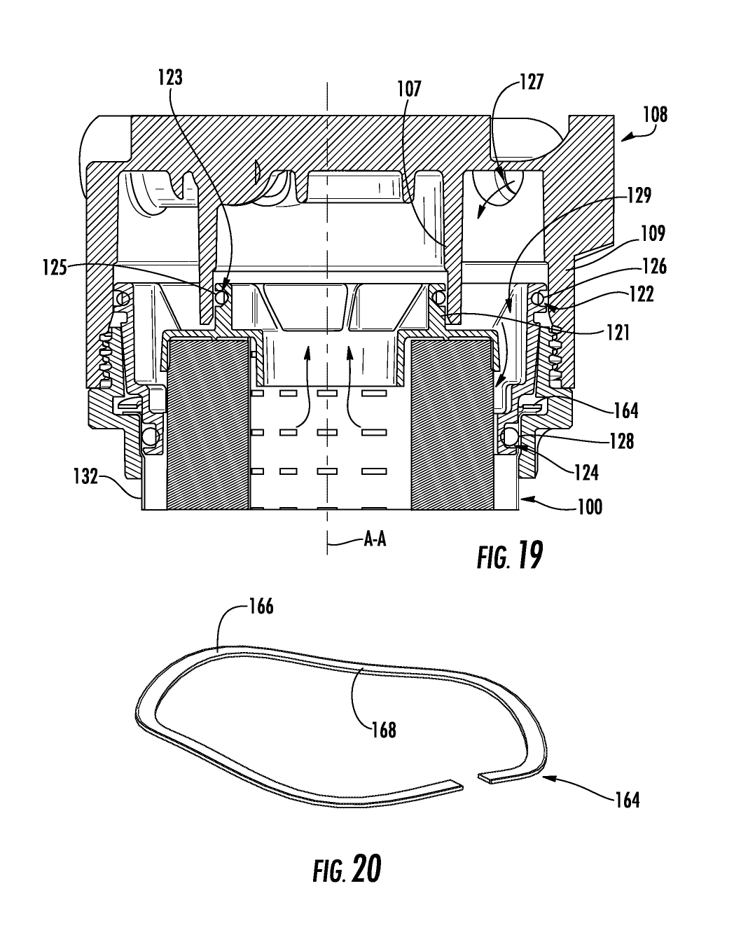

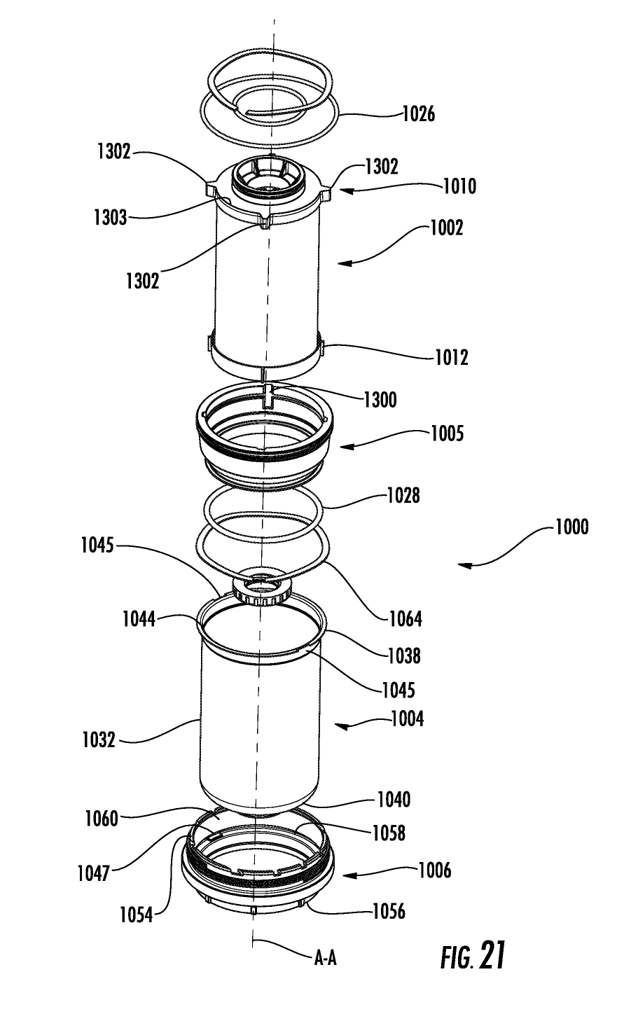

The second seal member 128 (FIG. 2) creates a second seal with the inner surface of the sidewall 134, fluidly sealing the cartridge and preventing leakage between the first end cap 110 and the housing 104. In the embodiment shown in FIGS. 17 and 18, the sidewall 132 of the housing 104 flares slightly radially outwardly adjacent the first open end 138. A ring 131 of the sidewall 132 located at the radially outward flare is disposed between a seat 133 and the first open end 138, and the inner surface 134 of the ring 131 creates the second seal with the second seal member 128. The seat 133 and first end cap cylindrical wall 116 are configured such that the seat 133 supports the second peripheral rim 120 (FIG. 1), thereby axially supporting the filter element 102 within the housing 104.

In the embodiment shown in FIGS. 1 and 17, the housing second end 140 defines a drain 142. The drain 142 has generally cylindrical sides 146 and defines a drain port 148. As shown in FIG. 1, the drain sides 146 and the drain port 148 may receive a cylindrical washer 150 which is configured to mate with a valve (not shown) via a threaded, bayonet, or similar connector system.

As shown in FIG. 16, the flange may define an aperture 145 configured to receive an anti-rotation member 147 projecting from the circumferential shoulder 158 of the collar 106 (see FIGS. 3, 5, 8 and 11). The anti-rotation member 147 is preferably a raised projection having a rectangular sectional configuration. The aperture 145 and anti-rotation member 147 cooperate to rotationally secure the housing 104 within the collar 106 and ensure that the housing does not rotate relative to the collar 106.

Referring to FIGS. 3, 5, 8 and 11, the collar 106 includes a stepped quazi-annular sidewall 152 having first and second axial ends 154 and 156, respectively. A shoulder 158 projects radially inwardly from an inner surface 160 of the annular sidewall 152 axially intermediate the first and second axial ends 154 and 156. The annular sidewall 152 is sized to receive and circumscribe the sidewall 132 of the housing 104, while the shoulder 158 of the collar 106 and the ledge 130 of the upper end cap 110 are sized to radially overlap. The radial overlap between the ledge 130 and the shoulder 158 traps the flange 144 between the two structures (see FIGS. 2, 4, 7 and 10). The filter element 102 is thus axially supported within the cartridge 100 by the upper end cap 110. As will be discussed in further detail below, a plurality of embodiments are contemplated to provide a connection between the element 102, housing 104 and/or collar 106. The connection further secures the element 102 within the cartridge 100 and prevents relative movement between the components.

In one embodiment shown in FIGS. 6 and 12, an axially-oriented surface 151 extends between first and second radially-oriented surfaces 153 and 155, respectively, intermediate the first and second axial ends 154 and 156. The axially-oriented surface and first and second radially-oriented surfaces 153 and 155 define a circumferential pocket 162. The second radially-oriented surface 155 is contiguous with the shoulder 158.

As shown in FIGS. 2, 4, 10 and 19, the pocket 162 receives a wave spring 164. Referring to FIG. 20, the wave spring 164 undulates between an alternating series of crests 166 and troughs 168. The crests and troughs 166 and 168 exert opposed forces to secure the wave spring 164 partially radially within pocket 162. The crests 166 also engage the ledge 130 and the crests 168 engage the flange 144 and provide opposed axial forces to secure the housing 104 against the second radially-oriented wall 155 and the shoulder 158.

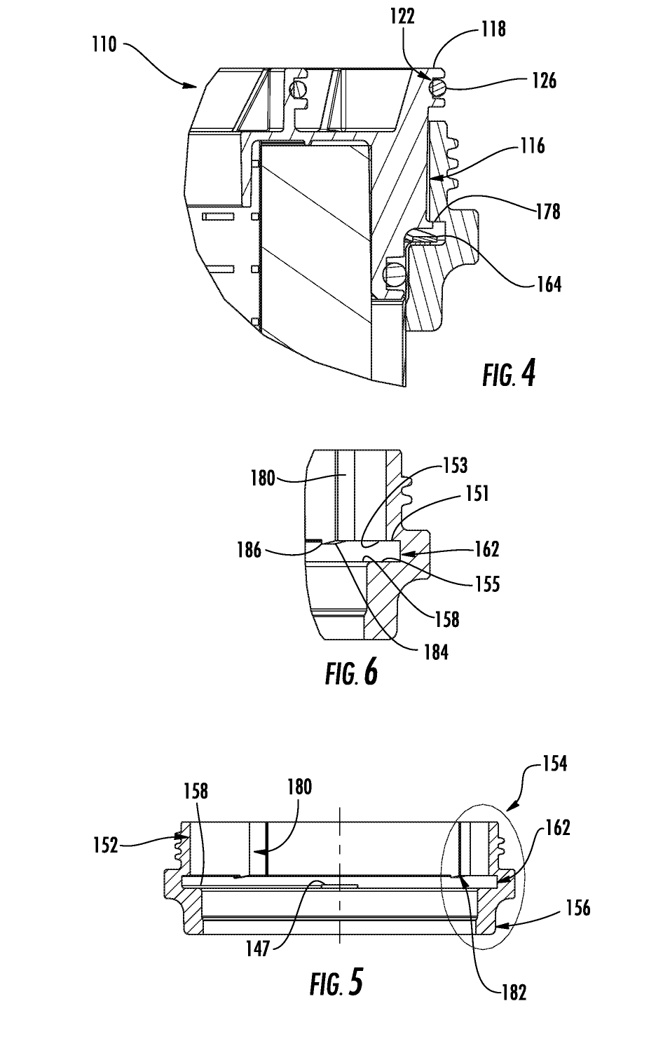

A number of different embodiments for securing the filter element 102, the housing 104 and the collar 106 are also contemplated in connection with the present disclosure. FIGS. 1-3 show an embodiment where a snap connector system is provided between the filter element 102 and the collar 106; FIGS. 4-6 show an embodiment where a bayonet connection is provided between the filter element 102 and the collar 106; FIGS. 7-9 show an embodiment where a threaded connection is provided between the filter element 102 and the collar 106; FIGS. 10-12 show an alternate embodiment of the threaded connection depicted in FIGS. 7-9; and FIGS. 13-15 show an embodiment where a crimped connection is provided between the filter element 102 and the housing 104.

### I. The Embodiments of FIGS. 1-3

As shown in FIGS. 1-3, a snap connector system secures the upper end cap 110 to the collar 106. Referring specifically to FIG. 3, a plurality of axial slots 170 separate angularly spaced snap fingers 172 projecting from the collar first axial end 154.

The snap connector mating system includes a male and a female connector portion, 174 and 176, respectively. In the embodiment shown in FIGS. 2 and 3, the male snap connector portion 174 projects from the snap fingers 172 radially toward the longitudinal axis A-A, while the female connector portion 176 is defined on an outer surface of the cylindrical wall 116 and oriented radially away from the longitudinal axis A-A. In another embodiment of the snap connector mating system (not shown), the female connector portions 176 are defined on the snap fingers 172 and the male snap connector portion projects radially away from the outer surface of the cylindrical wall 116.

Once the male snap connector portion 174 engages the female snap connector portion 176, the upper end cap 110, the collar 106 and the housing 104 cooperate to secure the filter element within the housing. In the embodiment where a wave spring 164 is received in a circumferential pocket 162, the wave spring crests and troughs 166 and 168 provide additional axial forces securing the flange 144 against the shoulder 158. The wave spring 164 secures the collar 106 to the housing 104.

The snap connector mating system provides a robust connection between the filter element 102 and the collar 106. In the embodiment shown in FIGS. 1-3, the male and female snap connector portions 174 and 176 are configured such that the filter element 102 cannot be replaced once the male snap connector portion 174 engages the female snap connector portion 176 without breaking the snap fingers 172. One of ordinary skill in the art will appreciate that subtle changes in the structural configuration of the male and female snap connector portions 174 and 176 and/or the collar 106 will produce a cartridge 100 that is replaceable once the consumable filter element 102 has reached the end of its usable lifespan.

The collar 106 supports the cartridge 100 relative to the base 108, so the base/cartridge connection is not dependent upon the snap connector.

### II. The Embodiments of FIGS. 4-6

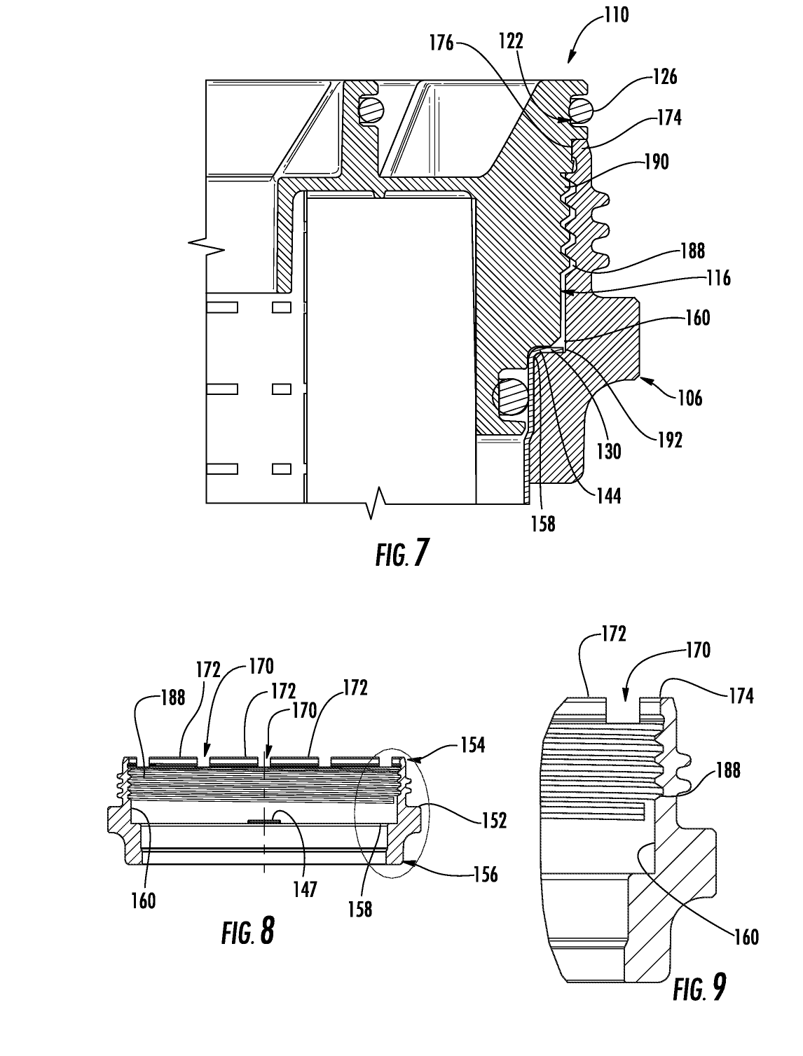

In the embodiments shown in FIGS. 4-6, a bayonet connection secures the upper end cap 110 to the collar 106. The bayonet connector is configured for use with the embodiment of the collar 106 defining the inner circumferential pocket 162. As shown in FIG. 4, a plurality of tabs 178 project radially outwardly from the cylindrical wall 116. Referring to FIGS. 5 and 6, a corresponding plurality of axially-oriented slots 180 are defined on an inner surface of the collar 106.

The axial slots 180 communicate with the circumferential pocket 162. A plurality of barbs 182 project into the pocket 162 from the first radially-oriented surface 153 at the point of communication between the axial slots 180 and the pocket 162. Referring specifically to FIG. 6, each barb 182 includes a ramp surface 184 and a retention shoulder 186.

In the embodiment shown in FIG. 4, the wave spring 164 provides additional axial retention forces, which urge the tabs 178 against the first radially-oriented surface 153. The wave spring 164 ensures that the tabs 178 are secured within the pocket 162, and cooperate with the barbs 182 to prevent the first end cap 110 from rotating past the retention shoulder 186 and disengaging the first end cap 110 from the collar 106.

To engage the ledge 130 with the shoulder 158 and trap the flange 144, the tabs 178 are first inserted into the axially-oriented slots 180. The first end cap 110 is subsequently axially pushed until the tabs 178 are received in the pocket 162. Once the pocket 162 receives the tabs 178, the first end cap 110 is rotated until the tabs 178 ride up the ramp surface 184 and past the retention shoulder 186. As the tabs 178 ride up the ramp surface 184, the tabs 178 and the ledge 158 axially compress the wave spring 164. Once the tabs 178 rotate past the retention shoulder 186 the wave spring 164 rebounds, urging the ledge 158 and tabs 178 against the first radially-oriented surface 153, and urging the flange 144 against the second radially-oriented surface 155. To disengage the first end cap 110 from the collar 106, the previously mentioned steps are sequentially repeated in reverse-order.

### III. The Embodiments of FIGS. 7-9

In the embodiments shown in FIGS. 7-9 a threaded connector system secures the upper end cap 110 to the collar 106. The inner surface 160 of the collar defines a female portion 188 of the threaded connector system. A male portion 190 of the threaded connector system projects from the cylindrical wall 116.

A chamfer 192 is provided between the ledge 130 and the cylindrical wall 116. The chamfer 192 aids in installation of a replacement filter element 102. A sharp transition between the ledge 130 and the cylindrical wall 116 otherwise would potentially catch the first axial end 154 or the inner surface 160 of the collar 106 during axial insertion of the element 102 or engagement of the male and female connector portions 188 and 190. Thus, the chamfer 192 ensures that axially inserting of the replacement element 102 within the housing 104 and engagement of the threaded connector system between the upper end cap 110 and the collar 106 is relatively smooth.

In the embodiment shown in FIGS. 7-9, the collar 106 also includes the axial slots 170 defined between the snap connector fingers 172. Male and female snap connector portions 174 and 176, similar to those provided in the embodiment of FIGS. 1-3, are also included. In comparison with the snap connector system shown in FIGS. 1-3, the male snap connector portion 174 and the female snap connector portion 176 are shorter and shallower in the embodiment of FIGS. 7-9. A detent and a corresponding receptacle (not shown) may alternatively be provided on the snap fingers 172 and the cylindrical wall 116, respectively. The snap connector system provides positive feedback during engagement of the threaded connector system. When the male and female connector portions 188 and 190 are completely engaged, the male snap connector portion 174 will simultaneously engage the female snap connector portion 176, providing an audible and tactile indication that the first end cap 110 is completely engaged with the collar 106.

### IV. The Embodiments of FIGS. 10-12

The embodiments shown in FIGS. 10-12 employ a similar threaded connector system to the one depicted in FIGS. 7-9. The collar 106 in the embodiment of FIGS. 10-12 includes the pocket 162 and wave spring 164 in addition to the snap fingers 172, and male and female connector portions 188 and 190. The wave spring 164 secures the collar 106 to the housing 104.

As seen in FIG. 10, the shoulder 130 of the first end cap 110 has a sharper transition than the chamfer 192 shown in the embodiment in FIGS. 7-9. While the shoulder 130 may have a chamfer 192, the shoulder 130 in the embodiment shown in FIG. 10 projects from the cylindrical wall 116 axially closer to the first peripheral rim 118 to accommodate the force of the wave spring 164.

### V. The Embodiments of FIGS. 13-15

As seen in FIGS. 13-15, a crimped connection may secure the filter element 102 within the housing 104. Preferably, it is the second end of the housing 140 which is crimped to axially secure the filter element 102 within the housing 104. An alternate embodiment of the second end cap 112 best seen in FIGS. 13 and 14 creates a strong connection between the filter housing 104 and the filter element 102. A plurality of supports 194 project axially away from the second end cap 112. The supports 194 may comprise struts, or fins, or other similar structural features which axially position the filter element 102, and define fuel flow paths 196 between the supports 194, allowing water run-off from the filter media 111 to pass through the drain port 148.

The supports 194 are connected to the cylindrical washer 150 axially opposite the filter second end cap 112. The washer 150 defines a radially-outwardly facing circumferential groove 198. The cylindrical sides 146 of the drain 142 receive the washer 150. The sidewalls 146 of the drain are crimped into the circumferential groove 198, retaining the filter element 102 within the housing 104 at the second end 140.

An inner surface 200 of the washer 150 is configured to mate with the valve (not shown). As shown in FIGS. 13 and 15, the inner surface 200 may define one half of a threaded connector system. Alternatively, a bayonet connector system (not shown) may be utilized to connect the valve to the washer 150.

### VI. The Embodiment of FIGS. 21-49

With reference to FIGS. 21-49, an alternative embodiment of the connector system between the housing 104, collar 106 and first end cap 110 of FIGS. 1-20 is illustrated. A filter cartridge 1000 in accordance with the disclosed embodiment of FIGS. 21-49 has a longitudinal axis A-A and includes a filter element 1002, a housing 1004 and first and second collars, 1005 and 1006, respectively.

One of ordinary skill in the art will appreciate that the housing 1004 has generally the same structure and function as the housing 104, and that the second collar 1006 has generally the same structure and function as the collar 106 described above and depicted in FIGS. 1-20. The embodiment of FIGS. 21-49 differ from the embodiments depicted in FIGS. 1-20 in that a connector system is configured between the first collar 1005 and the second collar 1006.

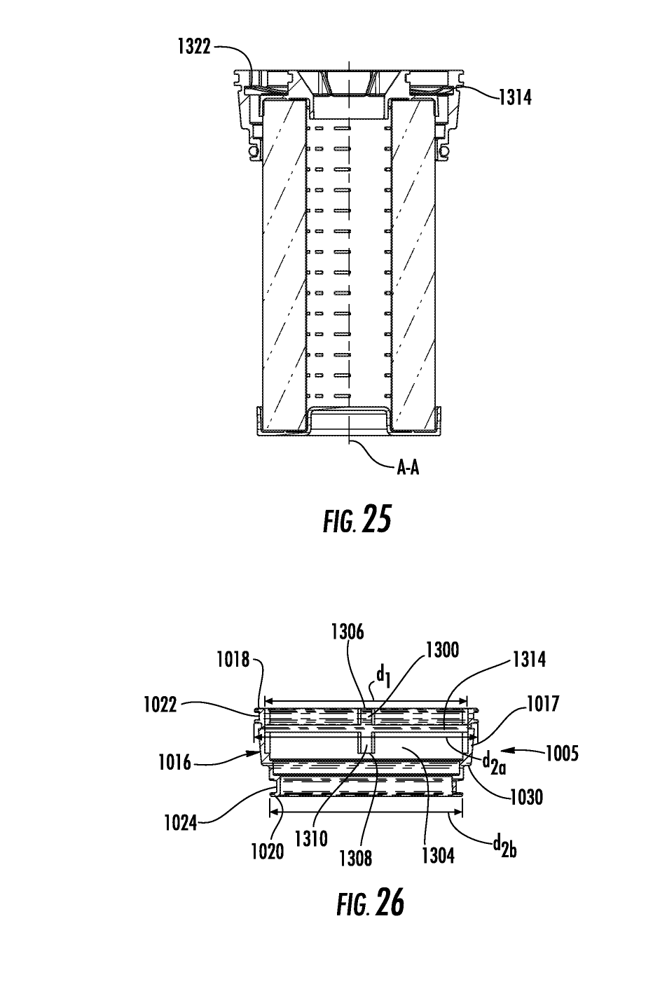

Referring to FIGS. 24 and 26, the first collar 1005 has a quazi-annular, multi-surface, stepped wall 1016 having an inner diameter d₁, and first and second outer diameters, d₂ₐ and d_{2b}. The first collar annular wall 1016 extends axially between first and second peripheral rims 1018 and 1020, respectively. The annular wall defines first and second seal glands 1022 and 1024. The first seal gland 1022 is defined adjacent the first peripheral rim 1018 and the second seal gland 1024 is defined adjacent the second peripheral rim 1020. The seal glands 1022 and 1024 are oriented radially away from the longitudinal axis A-A and receive first and second O-ring seal members 1026 and 1028, respectively.

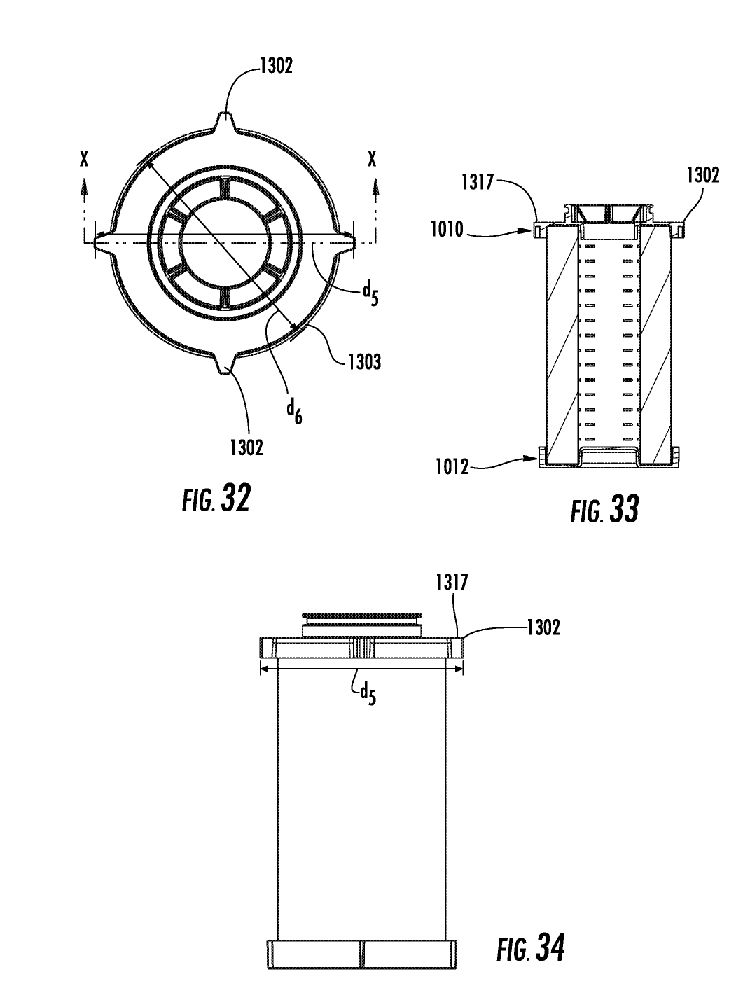

Much like the first seal gland and seal member of the embodiments shown in FIGS. 1-20, the first seal gland 1022 and first seal members 1026 are configured to seal against a surface of a filter base (not shown) to form an axially sealing interface, and direct the flow of fluid through a filter assembly (not shown) in a similar manner described above in paragraphs [0067] through [0068]. As will be described in greater detail below, the first end cap 1010 may have first and second diameters d₅ and d₆ (FIG. 32), which define a plurality of peripheral flow ports 1312 (FIG. 30) between a first end cap circumferential periphery 1303 and a first collar inner surface 1304. The peripheral flow ports 1312 act to direct fuel through the filter assembly in a similar manner to the filter ports 129 described above in paragraph [0068].

As best seen in FIGS. 24 and 26 the first collar surface having the first outer diameter d₂ₐ is disposed adjacent the first seal gland 1022, and the first collar surface having the second outer diameter d_{2b} is disposed adjacent the second seal gland 1024. A ledge 1030 projects radially outwardly from an outer surface 1017 of the first collar annular wall 1016 where the annular wall 1016 transitions between the first and second outer diameters d₂ₐ and d_{2b}.

Referring to FIGS. 21, 23, 24 and 26, the housing 1004 has a generally cylindrical sidewall 1032. The sidewall 1032 is coaxial with the longitudinal axis A-A. The sidewall 1032 has inner and outer surfaces 1034 and 1036, respectively, and defines an open first end 1038 and an axially opposite second end 1040. A flange 1044 projects radially away from the outer surface 1036 at the open first end 1038. The flange 1044 cooperates with the first collar 1005 and the second collar 1006 to retain the filter element 1002 within the housing 1004.

Similar to the embodiment described above with respect to FIGS. 1-20, the second seal member 1028 creates a seal with the inner surface of the sidewall 1034, fluidly sealing the cartridge and preventing leakage between the first collar 1005 and the housing 1004 (see FIGS. 23 and 24). In the disclosed embodiment, the sidewall 1032 of the housing 1004 flares slightly radially outwardly adjacent the first open end 1038. A ring 1031 of the sidewall 1032 located at the radially outward flare is disposed between a seat 1033 and the first open end 1038, and the inner surface 1034 of the ring 1031 creates the second seal with the second seal member 1028 (FIGS. 24, 38 and 47). As will be described in greater detail below, the first end cap 1010 of the filter element 1002 is connected to the first collar 1005 via a plurality of axially-oriented grooves 1300. The seat 1033 and first collar second outer diameter d_{2b} are configured such that the seat 1033 supports the second peripheral rim 1020 of the first collar 1005, thereby also axially supporting the filter element 1002 within the housing 1004.

As shown in FIGS. 21, 23 and 24 the flange may define an aperture 1045 configured to receive an anti-rotation member 1047 projecting from a circumferential shoulder 1058 of the second collar 1006. The anti-rotation member 1047 is preferably a raised projection having a rectangular sectional configuration. The aperture 1045 and anti-rotation member 1047 cooperate to rotationally secure the housing 1004 between the first and second collars 1005 and 1006 and ensure that the housing does not rotate relative thereto.

Referring to FIGS. 21 and 23, the second collar 1006 includes an annular sidewall 1052 having first and second axial ends 1054 and 1056, respectively. The second collar 1006 has an inner surface with a first inner diameter d₃ adjacent the first axial end 1054 sized to receive the first collar surface having the first outer diameter d₂ₐ. The second collar also includes a surface having a second inner diameter d₄ adjacent the second axial end 1054. A shoulder 1058 projects radially inwardly from an inner surface 1060 of the annular sidewall 1052 axially intermediate the first and second axial ends 1054 and 1056, where the second collar annular sidewall 1052 transitions between the second collar first and second diameters d₃ and d₄. The second collar second inner diameter d₄ is sized to receive and circumscribe the sidewall 1032 of the housing 1004, while the shoulder 1058 and the ledge 1030 of the first collar 1005 are sized to radially overlap. The radial overlap between the ledge 1030 and the shoulder 1058 traps the flange 1044 between the two structures (see FIGS. 23 and 24). Because the filter element 1002 is connected to the first collar 1004 the filter element 1002 is thereby axially supported within the cartridge 1000 by the first collar 1005.

As shown in FIGS. 24, 38 and 47, the second collar 1006 has an axially-oriented surface 1051 extending between first and second radially-oriented surfaces 1053 and 1055, respectively, intermediate the first and second axial ends 1054 and 1056. The axially-oriented surface 1051 and first and second radially-oriented surfaces 1053 and 1055 define a circumferential pocket 1062. The second radially-oriented surface 1055 is contiguous with the shoulder 1058. The pocket 1062 receives a wave spring 1064 having a similar configuration and providing axial retentive forces in a manner similar to the wave spring 164 described above in paragraph [0075].

The embodiment depicted in FIGS. 21-49 shows a snap connector system where the second collar defines a continuous circumferential pocket 1068 configured to receive a wave spring 1064. The connector system in the disclosed embodiment is similar to the system described with respect to FIGS. 1-3, however one of ordinary skill in the art will appreciate that the connector system between the housing 1004, first collar 1005 and second collar 1006 may be altered to utilize any of the connector systems discussed above with respect to FIGS. 1-3, 4-6, 7-9, 10-12, and 13-15. One of ordinary skill will appreciate that the connector system of FIGS. 1-20 need only be altered such that the first collar 1005 is configured to have the connector portion of the first end cap 110 and the second collar 1006 be configured to have the connector portion of the collar 106.

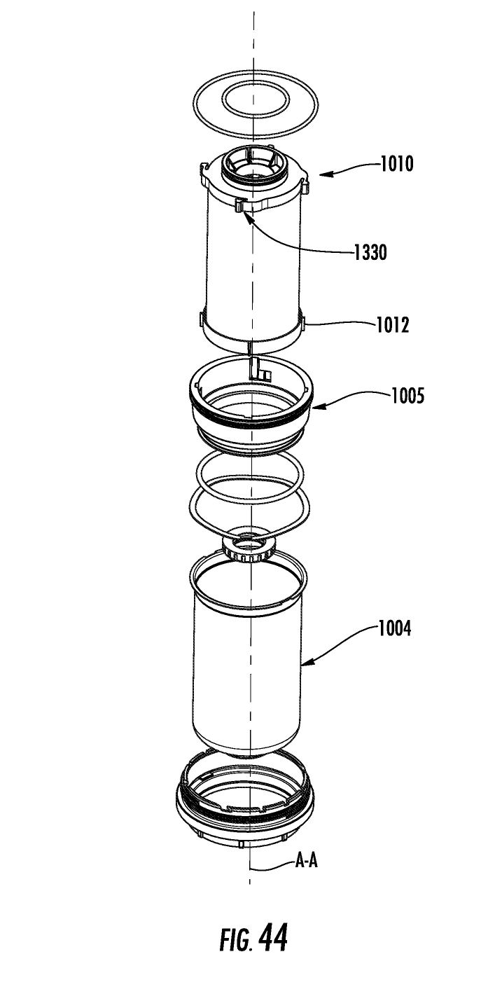

A number of different embodiments for securing the filter element 1002 to the filter cartridge are also contemplated in connection with the present disclosure. FIGS. 21-34 show an embodiment where a plurality of radial projections are secured within corresponding axially-oriented grooves by a circular retaining clip; FIGS. 35-43 show an embodiment wherein a plurality of barbs disposed on a surface oriented facing the longitudinal axis of an axially-oriented groove, each of which retains a plurality of peripherally extending arms within the corresponding axially-oriented groove; FIGS. 44-49 show an alternative embodiment of the connector system shown in FIGS. 35-43 where the barbs are each disposed on a surface oriented facing the longitudinal axis of a plurality of interrupted circumferential grooves, and each interrupted circumferential groove is defined in communication with the axial grooves.

A. The Filter Element Connector System of FIGS. 21-34

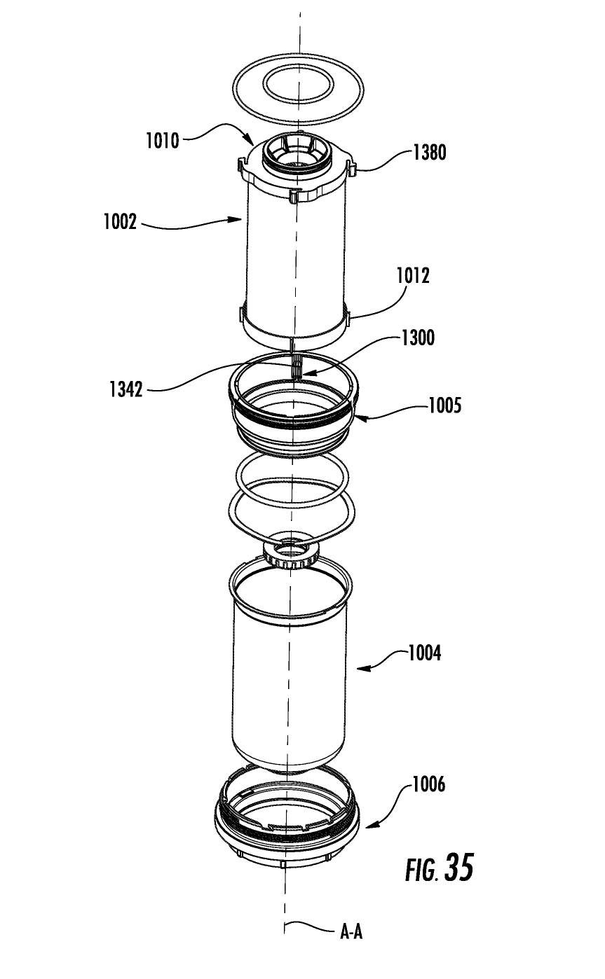

As shown in FIGS. 21-34 a connector system for reversibly securing the first end cap 1010 of the filter element 1002 to the first collar 1005 includes a plurality of radial projections 1302 sized to fit within axially-oriented grooves 1300. The radial projections are disposed at a first end cap circumferential periphery 1303. In the disclosed embodiment, the radial projections 1302 are uniform in length, and each radial projection 1302 is configured diametrically opposite one other radial projection 1302. Accordingly, the first end cap has the first diameter d₅ where each radial projection projects from the first end cap 1010, and the second, smaller diameter, d₆ as measured elsewhere along the circumferential periphery 1303 (FIGS. 32 and 34).

Referring to the embodiment depicted in FIGS. 21, 26, and 29-34, the axially-oriented grooves 1300 are defined on an inner surface 1304 of the first collar 1005. The axially-oriented grooves 1300 are sized such that the inner diameter d₁ of the first end cap 1005 is enlarged at each axially-oriented groove 1300 to be approximately equal to the first end cap first diameter d₅. The axially-oriented grooves 1300 extend between first and second ends 1306 and 1308. As best seen in FIGS. 26 and 31, the axially-oriented groove second end 1308 defines a radially-oriented axial groove surface 1310. The radial projections 1302 abut the radial groove surface 1310, and thereby axially support the filter element 1002 within the filter cartridge 1004.

As best seen in FIG. 30, the first end cap second diameter d₆ is smaller than the first collar inner diameter d₁. The size difference between the first end cap second diameter d₆ and the first collar inner diameter d₁ defines the peripheral fluid flow port 1312 between the first end cap circumferential periphery 1303 and the inner surface of the first collar 1304.

As best seen in FIGS. 25 and 26, the first collar inner surface 1304 defines a continuous circumferential groove 1314. The continuous circumferential groove 1314 is oriented transverse to the longitudinal axis A-A and intersects the plurality of axially-oriented grooves 1300 intermediate the axially-oriented groove first and second ends 1306 and 1308. The continuous circumferential groove is sized to receive a circular retaining clip 1316 configured to engage a first surface 1317 of the first end cap 1010 and axially retain the radial projections within the axial groove.

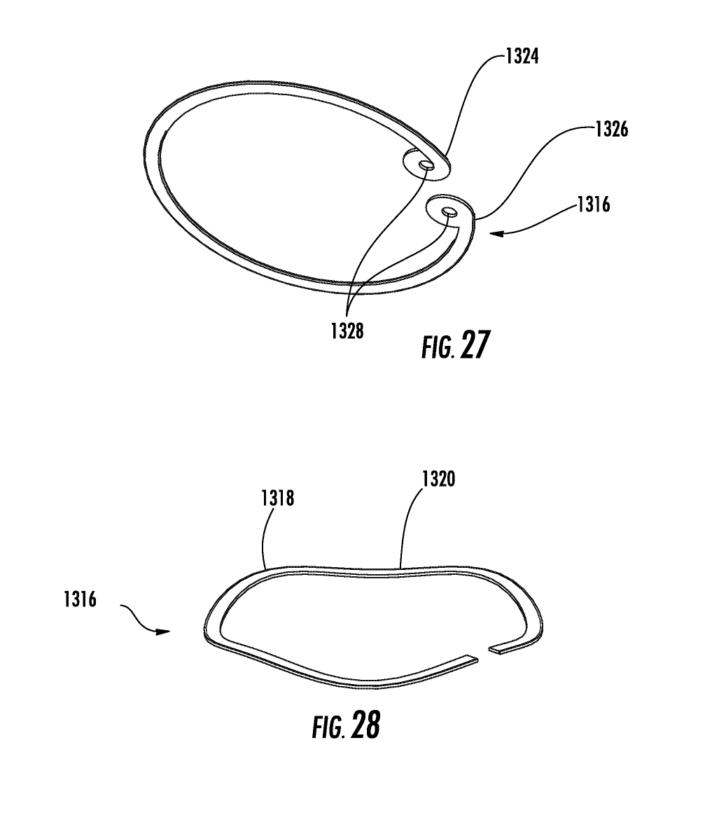

FIGS. 27 and 28 show two embodiments of the circular retaining clip 1316. In the embodiment shown in FIG. 28, the circular retaining clip 1316 is a resilient annular member. Similar to the wave spring 1064 received in the pocket 1062 described in connection with the second collar 1006, and the embodiment of the filter cartridge depicted in FIGS. 1-5 and 10-12, the resilient undulating member has a plurality of alternating crests and troughs 1318 and 1320, respectively. Referring to FIGS. 25 and 31, the crests 1318 engage a radially-oriented upper surface 1322 of the circumferential groove 1314, while the troughs engage the first surface 1317 of the first end cap 1010 to exert axially opposite forces.

In the embodiment shown in FIG. 27, the circular retaining clip 1316 is a planar c-shaped clip. The c-shaped clip is planar in a direction oriented transverse to the longitudinal axis A-A and has first and second clip ends 1324 and 1326. The c-shaped clip defines a gap between the first and second clip ends 1324 and 1326. The first and second clip ends 1324 and 1326 may each include a handle 1328 to allow for easier manipulation of the first and second clip ends 1324 and 1326. Drawing the clip ends together to eliminate the gap allows the c-shaped clip to be reversibly secured within the circumferential groove 1314. Accordingly, the embodiment of the cartridge 1000 employing the c-shaped clip allows the filter element 1002 to be replaced separately from the housing 1004 and first and second collars 1005 and 1006.

B. The Filter Element Connector System of FIGS. 35-43

The embodiment disclosed in FIGS. 35 through 43 utilizes the axially-oriented grooves 1300 also employed in the embodiment shown in FIGS. 21-34. The axially-oriented grooves 1300 are specifically configured to mate with a male portion 1330 of a connector system disposed on the first end cap 1010 of the filter element 1002.

As best seen in FIG. 42, each of the male connector portion includes a base 1332 disposed at the circumferential periphery 1303 of the first end cap 1010. A plurality of arms 1334 project from the base 1332 and extend generally parallel to and spaced apart from the circumferential periphery 1303 between arm first and second ends 1336 and 1338, respectively. A tab 1340 projects radially outwardly in a direction transverse to the axis A-A at each of the arm second ends 1338.

Referring to FIGS. 36, 39, 40 and 43, the arms 1334 act as natural springs, and cooperate with a barb 1342 disposed intermediate each of the axially-oriented first and second groove ends 1306 and 1308 on a surface 1343 oriented facing the longitudinal axis A-A. Each of the barbs 1342 has a ramp surface 1344 and a retention shoulder 1346 configured to axially secure the upper end cap 1010 to the first collar 1005.

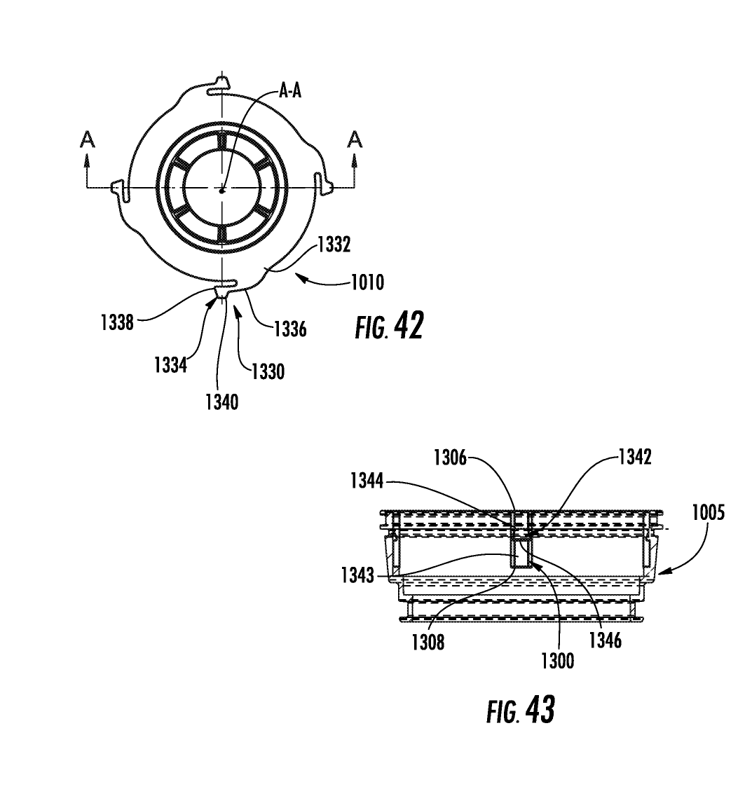

The filter element 1002 is secured to the first collar 1005 by axially inserting the tab 1340 of the male connector portions 1330 into the axially-oriented first groove end 1306. The first end cap 1010 is subsequently axially manipulated such that each of the tabs 1340 rides up the ramp surface 1344, deforming each of the arms 1334, until the tabs 1340 and past the retention shoulder 1346. Once the first end cap top surface 1317 passes the retention shoulder 1346, the arms 1334 snap back into place as seen in FIG. 40, and the retention shoulder 1346 retains the tabs against the radially-oriented surface 1310 and within the axial slot 1300. One of ordinary skill in the art will appreciate that the steps described above need only be reversed to disengage the connector system and remove the filter element 1002 from the housing 1004. Accordingly, the filter element 1002 of the disclosed embodiment may be replaced separately from the remainder of the cartridge 1000.

As best seen in FIGS. 36-39 and 42, each arm 1340 is configured diametrically opposite one other arm 1340. Like the embodiment disclosed in FIGS. 21-34, the first end cap first diameter d₅ is configured at the base of each arm 1332, and the first end cap second diameter d₆ is configured elsewhere along the circumferential periphery 1303. Similarly to the previously described embodiment in FIGS. 21-34, the second diameter d₆ is smaller than the first collar inner diameter d₁. The size difference between the first end cap second diameter d₆ and the first collar inner diameter d₁ creates a peripheral fluid flow port 1312 defined between the first end cap circumferential periphery 1303 and the inner surface of the first collar 1304.

C. The Filter Element Connector System of FIGS. 44-49

The filter element connector system of FIGS. 44-49 is similar to the connector system disclosed in FIGS. 35-43. The first end cap 1010 includes the male portion 1330 of a connector system, including the base 1332 and arms 1334, and configured as described above with respect to the embodiment of FIGS. 35-43. The embodiment disclosed in FIGS. 44-49 is distinguishable from the embodiments in FIGS. 35-43 in that the inner surface 1304 of the first collar 1005 also defines a plurality of circumferentially interrupted grooves 1348 (see FIG. 49), which form a bayonet connector system.

The circumferentially interrupted grooves 1348 are oriented transverse to the longitudinal axis A-A. The circumferentially interrupted grooves have first and second ends 1350 and 1352. Each of the circumferentially interrupted groove first ends 1350 is configured in communication with the axially-oriented groove second end 1308. The plurality of barbs 1342 are disposed intermediate the circumferentially interrupted groove first and second ends 1350 and 1352, on a surface 1353 oriented facing the longitudinal axis A-A.

To connect the filter element 1002 to the first collar 1005, the arms 1334 are inserted into the axially-oriented grooves 1300 and manipulated until the tabs 1340 abut the radially-oriented surface 1310 of the axially-oriented groove second end 1308. The first end cap 1010 is subsequently rotated about the longitudinal axis A-A such that each of the tabs 1340 rides up the ramp surface 1344, deforming each of the arms 1334, until the tabs 1340 pass the retention shoulder 1346. Once the first end cap top surface passes the retention shoulder 1346, the arms 1334 snap back into their original configuration as seen in FIG. 48, and the retention shoulder 1346 retains the tabs 1334 against the circumferentially interrupted groove second ends 1352. One of ordinary skill in the art will appreciate that the steps described above need only be reversed to disengage the connector system and remove the filter element 1002 from the housing 1004.

While preferred embodiments have been set forth for purposes of illustration, the foregoing descriptions should not be deemed a limitation of the invention herein. Accordingly, various modifications, adaptations and alternatives may occur to one skilled in the art without departing from the spirit of the invention and scope of the claimed coverage.

What is claimed is:

1. A filter cartridge having a longitudinal axis for use with a filter base, said cartridge comprising:
a housing having a generally cylindrical sidewall coaxial with the longitudinal axis and defining an open first end and an axially opposite second end, said sidewall having inner and outer surfaces, and a flange projecting radially away from said outer surface of said housing at said open first end;
a first collar having a generally annular wall having inner and outer diameters and extending axially between first and second peripheral rims, an inner surface of said annular wall defining a plurality of axially-oriented grooves extending between first and second ends, said annular wall defining first and second seal glands adjacent said first and second peripheral rims, respectively, said seal glands oriented radially away from the longitudinal axis and receiving first and second seal members, respectively, and a ledge projecting radially outwardly from said annular wall intermediate said first and second peripheral rims;
a filter element having a ring of filter media circumscribing the longitudinal axis and extending axially between first and second end caps, said first end cap having a plurality of radial projections at a circumferential periphery and defining a fluid flow opening coaxial with the longitudinal axis; and
a second collar having an annular sidewall having first and second axial ends and a first inner diameter sized to receive said outer diameter of said first collar and a second inner diameter sized to receive and circumscribe the sidewall, a circumferential shoulder projecting from an inner surface of said sidewall intermediate said first and second axial end where said second collar inner diameter transitions from said first inner diameter to said second inner diameter, said ledge configured to radially overlap with said shoulder and axially retain the flange therebetween;
wherein said radial projections are sized to fit within said axially-oriented grooves and suspend said filter element within said housing.

2. The filter cartridge of claim 1, wherein said inner surface of said first collar defines a continuous circumferential groove oriented transverse to the longitudinal axis and intersecting said plurality of axially-oriented grooves intermediate said axially-oriented groove first and second ends.

3. The filter cartridge of claim 2, wherein a generally circular retaining clip is received within said continuous circumferential groove and configured engage a top surface of said first end cap at said radial projections, axially securing said filter element against a radially-oriented surface of said axial groove second end.

4. The filter cartridge of claim 3, wherein said generally circular retaining clip is generally planar in a direction oriented transverse to the longitudinal cartridge axis and defines a gap between first and second circumferential clip ends, each end having a handle that may be reversibly secured within said continuous circumferential groove by drawing said first and second clip ends together to eliminate said gap.

5. The filter cartridge of claim 3, wherein said generally circular retaining clip comprises a resilient annular member undulating between a plurality of alternating crests and troughs configured to secure said resilient annular member at least partially radially within said continuous circumferential groove such that said wave spring troughs also engage a top surface of said first end cap at said radial projections, axially securing said filter element against a radially-oriented surface of said axial groove second end.

6. The filter cartridge of claim 3, wherein said projections comprise a plurality of radially projecting fingers.

7. The filter cartridge of claim 1, wherein each of said projections have a base at said circumferential periphery and an arm projects from said base extending generally parallel to and spaced apart from said circumferential periphery between arm first and second ends, a tab projects from said arm second end.

8. The filter cartridge of claim 7, wherein each of said axially-oriented grooves comprises a female portion of a connector system configured to mate with said tab of one of said arms, each female connector portion having a barb disposed intermediate said axial groove first and second ends, each of said barbs having a ramp surface which projects radially away from a surface of said axial grooves oriented facing said longitudinal axis and a retention shoulder which extends transversely to the axis between said ramp surface portion and said surface of said groove, and wherein axially inserting said arm such that said tab rides up said ramp surface and past said retention shoulder reversibly secures said filter element within said housing.

9. The filter cartridge of claim 7, wherein a plurality of interrupted circumferential grooves oriented transverse to the longitudinal axis are defined in communication with said second end of each of said axially-oriented grooves, each of said interrupted circumferential grooves having first and second circumferential ends, said first end configured in communication with said axially-oriented grooves, and said grooves comprise a female portion of a connector system configured to mate with said male connector portion of one of said arms, each female connector portion having a barb disposed intermediate said interrupted circumferential groove first and second ends, each of said barbs having a ramp surface which projects radially away from a surface of said interrupted circumferential grooves oriented facing said longitudinal axis and a retention shoulder which extends transversely to the axis between said ramp surface and said surface of said interrupted circumferential grooves, and wherein axially inserting said arm until said male connector portion abuts a radially-oriented surface of said axial groove second end and rotating said first end cap such that said male connector portion rides up said ramp surface and past said retention shoulder reversibly secures said filter element within said housing.

10. The filter cartridge of claim 1, wherein said radial projections are spaced about said circumferential perimeter such that each radial projection is configured diametrically opposite one other radial projection.

11. The filter cartridge of claim 10, wherein said radial projections are uniform in radial length.

12. The filter cartridge of claim 11, wherein said first end cap has a first diameter where each radial projection projects from said first end cap, and a second diameter measured at said circumferential periphery intermediate said radial projections.

13. The filter cartridge of claim 12, wherein said first collar inner diameter and said first end cap second diameter are sized such that said first collar and said first end cap define a plurality of peripheral flow ports intermediate said first collar inner surface and said first end cap circumferential periphery.

14. A filter cartridge having a longitudinal axis for use with a filter base, said cartridge comprising:
a housing having a sidewall coaxial with the longitudinal axis and defining an open first end and an axially opposite second end, said sidewall having inner and outer surfaces, and a flange projecting radially away from said outer surface of said housing at said open first end;
a first collar having a generally annular wall including an inner diameter and first and second outer diameters, and extending axially between first and second peripheral rims, said first outer diameter configured adjacent said first peripheral rim and said second outer diameter configured adjacent said second peripheral rim, said annular wall defining first and second seal glands adjacent said first and second peripheral rims, respectively, said seal glands oriented radially away from the longitudinal axis and receiving first and second seal members, respectively, a ledge projects radially outwardly from said annular wall intermediate said first and second peripheral rims where said first collar annular wall transitions between said first and second outer diameters, and an outer surface of said annular wall having one of a male or female portion of a connector system adjacent said first peripheral rim;
a filter element configured to be selectively received within said inner diameter of said first collar;
a second collar having an annular sidewall having first and second axial ends, a first inner diameter sized to receive said first outer diameter of said first collar, and a second inner diameter sized to circumscribe said housing and inner and outer surfaces, said inner surface having the other of said male or female portion of a connector system disposed adjacent said first axial end, and a circumferential shoulder projecting from said inner surface of said sidewall intermediate said first and second axial end where said annular sidewall transitions between said first and second inner diameters, said shoulder configured such that when said male and female portions of said connector system are joined said ledge and shoulder radially overlap axially retaining said flange between said ledge and said shoulder.

15. The filter cartridge of claim 14, wherein said first axial end of said second collar defines axial slots separating a plurality of snap fingers said snap fingers having one of either a male or a female snap connector portion and said outer surface of said first collar annular wall having the other of the male or female snap connector portion.

16. The filter cartridge of claim 15, wherein said male snap connector portion projects from said snap fingers radially toward the longitudinal axis, and said female snap connector portion is defined on said first collar outer surface and oriented radially away from the longitudinal axis.

17. The filter cartridge of claim 15, wherein a male snap connector portion projects radially away from an outer surface of said first collar annular wall and each of said snap fingers defines a female snap connector portion oriented radially toward the longitudinal axis.

18. The filter cartridge of claim 14, wherein said second collar annular sidewall has an inner surface defining a female portion of a mateable threaded connector system, and a male portion of said mateable threaded connection projects from said outer surface of said first collar annular wall adjacent said first peripheral rim.

19. The filter cartridge of claim 18, wherein the second collar defines axial slots between a plurality of snap fingers, said snap fingers having one of either a male or a female snap connector portion and an outer surface of said first collar annular wall having the other of the male or female snap connector portion, said snap connector portions preventing disengagement of said first collar from said second collar when said threaded connector system is in a fully engaged configuration.

20. The filter cartridge of claim 14, wherein said second collar inner surface has an axially-oriented surface extending between first and second radially-oriented surfaces defining a continuous circumferential pocket, said pocket disposed intermediate said second collar first and second axial ends, said second radially-oriented surface contiguous with said circumferential shoulder, said pocket receives a wave spring undulating between a plurality of crests and a plurality of troughs configured to secure said wave spring at least partially radially within said pocket such that said crests also engage said ledge and said troughs engage said flange to provide axial forces securing said housing against said shoulder.

21. The filter cartridge of claim 14, wherein a plurality of tabs project radially outwardly from said first collar annular wall adjacent said ledge, said second collar defines a corresponding plurality of axially-oriented slots and a circumferential pocket intermediate said first and second axial ends and communicating with said axial slots, a plurality of barbs project axially into said pocket adjacent each slot, each of said barbs having a ramp surface and a retention shoulder, and wherein rotating said upper end cap with respect to said collar such that said tabs ride up said ramp and past said retention shoulder reversibly secures said filter element within said housing.

22. The filter cartridge of claim 14, wherein said housing second end defines a drain having generally cylindrical sides and defining a drain port coaxial with the longitudinal axis, a plurality of supports extend axially from said second end cap and connect axially opposite said second end cap with a generally cylindrical washer having a radially outwardly facing circumferential groove, said drain sides are crimped to engage said groove and axially retain said filter element within said housing, said collar defines an annular pocket intermediate said first and second annular sidewalls.

23. The filter cartridge of claim 14, wherein at least one anti-rotation member projects from said circumferential shoulder and said flange defines a corresponding aperture sized to receive said anti-rotation member and prevent said housing from rotating relative to said collar.

24. The filter cartridge of claim 14, wherein said first collar annular wall tapers from said first peripheral rim to said second peripheral rim and said second collar annular sidewall tapers from said first axial end to said second axial end.

25. The filter cartridge of claim 14, wherein said housing sidewall projects slightly radially outwardly adjacent said open first end so as to provide a seat to support said first collar annular wall adjacent said second peripheral rim and a ring of said housing sidewall between said seat and said open first end creates a seal between said second seal member and said inner surface of said housing.

26. A method of constructing a filter cartridge having a longitudinal axis comprising:
providing a housing having a generally cylindrical sidewall coaxial with the longitudinal axis and defining an open first end and an axially opposite second end, said sidewall having inner and outer surfaces, and a flange projecting radially away from said outer surface of said housing at said open first end;
providing a first collar having a generally annular wall including an inner surface having an inner diameter and an outer surface having first and second outer diameters, said first and second outer diameters configured adjacent first and second peripheral rims of said annular wall, respectively;
providing a second collar having a generally annular sidewall including an inner surface having first and second inner diameters configured axially adjacent first and second axial annular sidewall ends, respectively;
inserting said housing radially inwardly of said generally annular sidewall of said second collar such that said second inner diameter circumscribes said outer surface of said housing sidewall;
connecting one of a male or female portion of a connector system disposed on an outer surface of said first collar adjacent said first peripheral rim to the other of said male or female portion of said connector system disposed on an inner surface of said second collar adjacent said first axial end such that a ledge projecting radially outwardly from said first collar annular wall intermediate said first and second peripheral rims and a circumferential shoulder projecting from said inner surface of said second collar annular sidewall intermediate said first and second axial ends overlap axially retaining said flange between said ledge and said shoulder; and
coupling a first end cap of a filter element to said first collar such that a plurality of radial projections configured at a circumferential periphery of said first end cap are received within a plurality of axially-oriented grooves defined on said first collar inner surface, axially retaining said filter element within said housing.

27. The method of constructing a filter cartridge of claim 26, wherein coupling said filter element first end cap and said first collar further comprises inserting a generally circular retaining clip at least partially radially within a continuous circumferential groove defined by said first collar inner surface and intersecting said axially-oriented grooves intermediate axially-oriented groove first and second ends, thereby securing said radial projections against a radially oriented surface of said axially-oriented groove second ends.

28. The method of constructing a filter cartridge of claim 27, wherein inserting said generally circular retaining clip comprises engaging a plurality of alternating crests and troughs of said retaining clip such that said troughs engage a surface of said first end cap at said radial projections securing said radial projections against said radially oriented surface of said axially-oriented grooves, and said crests engage a radially-oriented surface of said continuous circumferential groove.

29. The method of constructing a filter cartridge of claim 27, wherein inserting said generally retaining clip comprises manipulating handles of first and second clip ends of said circular retaining clip to draw said first and second clip ends together to eliminate a gap and inserting said retaining clip into said continuous circumferential groove such that a first planar surface of said clip engages a surface of said radial projections securing said radial projections against said radially oriented surface of said axially-oriented grooves, and a second planar surface of said clip engages a radially-oriented surface of said continuous circumferential groove.

30. The method of constructing a filter cartridge of claim 26, wherein inserting said filter element first end cap further comprises inserting a plurality of arms projecting from a corresponding plurality of bases at said first end cap circumferential periphery into said axially oriented grooves, wherein each arm extends generally parallel to and spaced apart from said circumferential periphery between first and second arm ends and has a tab projecting from said arm second end configured such that inserting said arms into said axially-oriented grooves causes said tab to ride up a ramp surface of a barb projecting radially toward the longitudinal axis, said barb disposed in said axially-oriented groves, wherein causing said arm to ride up said ramp deforms said arm until a top surface of said tab passes a retention shoulder snapping said arm back into its original position circumferentially parallel to and spaced apart from said circumferential periphery and reversibly securing said filter element within said housing.

31. The method of constructing a filter cartridge of claim 26, wherein coupling said filter element first end cap to said first collar comprises connecting male and female portions of a bayonet connector system, wherein one of said male or female portions of said bayonet connector system is disposed on said first end cap at a circumferential periphery, and the other of said male or female portions of said bayonet connector is disposed on an inner surface of said first collar.

32. The method of constructing a filter cartridge of claim 26, wherein connecting said first and second collars forms a seal between said inner surface of said housing sidewall and a seal member received by a seal gland oriented radially away from the longitudinal axis and defined axially adjacent said first collar second peripheral rim.

33. The method of constructing a filter cartridge of claim 26, wherein the step of connecting said connector system comprises disconnecting and connecting a threaded connection between said first collar outer surface and said second collar inner surface, said second collar inner surface having one of either a male or female threaded connector portion, and said first collar outer surface having the other of said male or said female threaded connector portion on an outer surface of said first end cap cylindrical wall.

34. The method of claim 33, wherein the step of connecting said connector system involves rotating said collar to connect said threaded connection until at least one detent carried by one of the second collar first axial end or the first collar annular wall engages at least one receptacle defined on the other of the second collar first axial end or the first collar annular wall adjacent said peripheral rim, thereby preventing disconnection of the threaded connection.

35. The method of claim 26, wherein the step of connecting said connector system comprises inserting a plurality of tabs projecting radially from said outer surface of said first collar adjacent said ledge into corresponding axially-oriented slots defined on said second collar inner surface, pushing said first collar until said tabs are received in a circumferential pocket defined intermediate said second collar first and second axial ends, and rotating said first end cap until said tabs ride up an engagement ledge and past a retention shoulder of a barb projecting into said pocket.
